(19) United States
(12) Patent Application Publication
(10) Pub. No.: US 2009/0202394 A1
(43) Pub. Date: Aug. 13, 2009

(54) VIAL WITH COAXIAL SMALL SAMPLE TUBE INSERT

(75) Inventors: Viet X. Nguyen, Wilmington, DE (US); Paul Powell, Wilmington, DE (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Palo Alto, CA (US)

(21) Appl. No.: 12/366,332

(22) Filed: Feb. 5, 2009

Related U.S. Application Data
(60) Provisional application No. 61/026,801, filed on Feb. 7, 2008.

(51) Int. Cl. B01L 3/00

(52) U.S. Cl. 422/102

(57) ABSTRACT

A container for holding a sample is presented. The container has a substantially cylindrical vial defining an interior cavity and a longitudinal axis. The vial has a first end, an opposed second end, and a circumferential sidewall. The first end of the vial is open for access to the interior cavity and the second end is closed. In one aspect, the circumferential sidewall has a first sidewall portion located proximate the first end projecting inwardly into the interior cavity, and a second sidewall portion positioned between the first sidewall portion and the second end projecting inwardly into the interior cavity.

This application claims the benefit of the filing date of U.S. provisional application Ser. No. 61/026,801 entitled “VIAL WITH COAXIAL SMALL SAMPLE TUBE INSERT,” which was filed on Feb. 7, 2008 and which is herein incorporated by reference.

### FIELD OF THE INVENTION

This invention concerns vials for holding liquid samples used in various analyses, and especially to vials for holding small sample volumes.

### BACKGROUND OF THE INVENTION

Vials, as shown at 10 in FIG. 1, used in automated analysis equipment, are typically formed of glass or other materials such as plastics and have a cylindrical sidewall 12 with a neck portion 14 surrounding and defining an opening 16 providing access to an interior cavity 18 defined by the sidewall. The neck portion 14 may have screw threads 20 for receiving a closure 22. Other retaining features, for example, adapted for crimp and snap type closures, are also feasible. The vial is sized to a set of standard dimensions to accommodate the automated analysis equipment. An exemplary standard vial may have a volume of 2 ml, a diameter of 11.6 mm and a length of 32.5 mm. The size, shape and dimensions of the vial are standardized to facilitate its handling during processing, allowing it to be loaded, transferred, filled and emptied with liquid samples, reagents and the like by the automated equipment rapidly and efficiently. Such automated equipment includes, for example, gas chromatography analyzers and liquid chromatography analyzers.

Filling or drawing liquid from the vial 10 is affected using a needle which is inserted through the opening 16. If there is only a small volume of liquid in comparison with the volume of the vial, the cylindrical shape of the vial makes drawing liquid from it difficult. The volume of liquid available may only be sufficient to provide a thin coating on the vial bottom and it may not be possible to position the needle tip beneath a free surface of the liquid deep enough to draw the sample from the vial. It is apparent that a vial which can handle small sample amounts (compared with the volume of the vial), and yet still have the significant outer dimensions and shape of a standard vial so that it can be handled by automated analysis equipment, would be advantageous for the processing of samples which are rare and expensive or for which only small amounts are available.

### SUMMARY OF THE INVENTION

The invention concerns a container for holding a sample. In one aspect, the container is a substantially cylindrical vial and comprises a sidewall which surrounds and defines an interior cavity. An opening is positioned at one end of the vial, which provides access to the interior cavity. A bottom encloses the other end. In another aspect, a first portion of the sidewall projects inwardly into the interior cavity. A second portion of the sidewall also projects inwardly into the interior cavity. The vial is dimensioned and shaped so that, for handling by automated analysis equipment, it is compatible as a replacement for a standard vial. That is, the differences in shape and dimensions between the vial and a standard vial do not adversely affect handling or transfer of the vial when it is used with automated analysis equipment.

The vial may be used as a vessel for holding a small volume of a liquid sample when it is used in conjunction with a substantially tubular insert. The insert has an open end and an oppositely disposed closed end. The insert is sized to fit within the interior cavity. In one aspect, the open end is aligned concentrically with the opening of vial. In another aspect, the closed end is tapered to reduce the volume of the insert and confine the sample so that it has some depth and a free surface facilitating drawing of the sample through a needle inserted within the insert. The insert has an outer surface which is sized so as to engage the first and second sidewall portions. Engagement between the first and second sidewall portions and the outer surface of the insert maintains the insert in coaxial alignment with the longitudinal axis A_{L}. By maintaining this coaxial alignment between the insert and the longitudinal axis, the chance that the needle will contact the insert and break upon insertion is reduced.

### BRIEF DESCRIPTION OF THE DRAWINGS

These and other features of the preferred embodiments of the invention will become more apparent in the detailed description in which reference is made to the appended drawings wherein:

FIG. 1 is a longitudinal sectional view of a vial according to the prior art; and

FIGS. 2-6 are longitudinal sectional views of various aspects of a vial and a tubular insert.

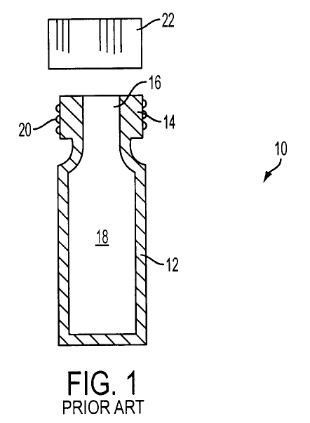

### DETAILED DESCRIPTION OF THE EMBODIMENTS

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a vial” can include two or more such vials unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where the event or circumstance occurs and instances where it does not.

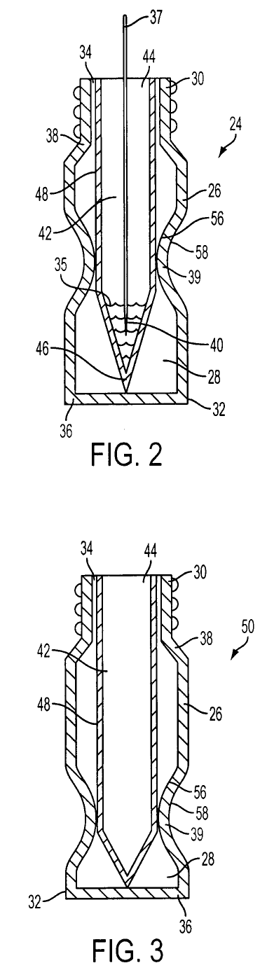

FIG. 2 shows an embodiment of a vial 24. In one aspect, the vial 24 comprises a sidewall 26 which surrounds and defines an interior cavity 28. The sidewall 26 has opposite ends 30 and 32. An opening 34 is positioned at one end, which provides access to the interior cavity. A bottom 36 encloses the other end 32. In another aspect, a first portion 38 of the sidewall 26 projects inwardly into the interior cavity. The first portion 38 is located proximate to the opening 34. A second portion 39 of the sidewall 26 also projects inwardly into the interior cavity 28. In this example the vial 24 is generally cylindrical in shape with a round cross section, when taken transverse to the longitudinal axis of the vial. In another aspect, the second sidewall portion 39 extends circumferentially around the entire sidewall. The vial is dimensioned and shaped so that, for handling by automated analysis equipment, it is indistinguishable from a standard vial. That is, the differences in shape and dimensions between the vial 24 and a standard vial do not adversely affect handling or transfer of the vial when it is used with automated analysis equipment.

The vial 24 may be used as a vessel for holding a small volume of a liquid sample 40 when it is used in conjunction with a substantially tubular insert 42. The insert 42 has an open end 44 and an oppositely disposed closed end 46. The insert 42 is sized to fit within the interior cavity 28. In one aspect, the open end 44 is aligned concentrically with the opening 34 of vial 24. In another aspect, the closed end 46 is tapered to reduce the volume of the insert and confine the sample 40 so that it has some depth and a free surface 35 facilitating drawing of the sample through a needle 37 inserted within the insert. Alternately, the closed end of insert 42 may have a flat configuration. The insert 42 has an outer surface 48 which is sized so as to engage the first and second sidewall portions 38 and 39. Engagement between the first and second sidewall portions and the outer surface 48 of the insert 42 maintains the insert in coaxial alignment with the longitudinal axis. By maintaining this coaxial alignment between the insert and the longitudinal axis, the chance that the needle 37 will contact the insert and break upon insertion is reduced.

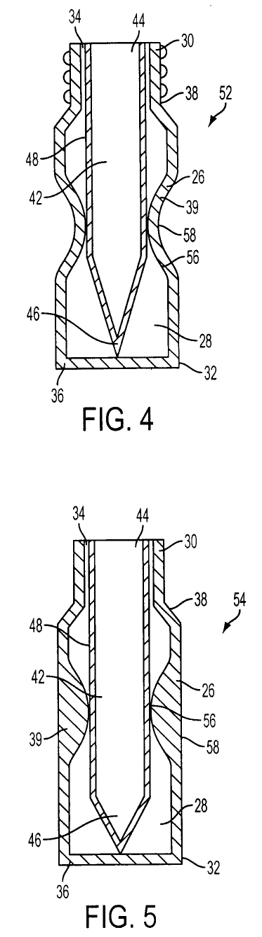

In the aspect shown in FIG. 2, the second sidewall portion 39 which projects into the interior cavity 28 is positioned approximately midway between the ends 30 and 32 of the sidewall 26. In another aspect, shown in FIG. 3, the second sidewall portion 39 is positioned nearer to the bottom 36 (end 32) than the other end 30. FIG. 4 illustrates another aspect, wherein the second sidewall portion 39 is positioned nearer to the opening 34 (end 30) than nearer the bottom 36.

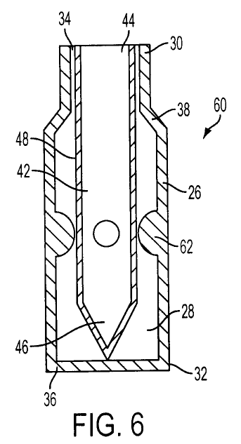

In the above-described aspects, the second sidewall portion 39 is formed by extending the sidewall 26 toward the interior cavity so that both its inner surface 56, and its outer surface 58 are curved, i.e., they both depart from the cylindrical shape defined by the other portions of the sidewall. As shown in aspect in FIG. 5, however, it is feasible to form the inwardly projecting second sidewall portion 39 by extending only the inner surface 56 into the interior cavity 28. This may be accomplished, for example, by a local thickening of the sidewall 26. The thickening may extend circumferentially around the sidewall. In yet another aspect, shown in FIG. 6, a plurality of discrete projections 62 are positioned on the sidewall between the first and second ends. The projections may extend into the interior cavity 28 to engage and support the insert 42 in coaxial alignment with the longitudinal axis.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A container for holding a sample, the container comprising:
a vial defining an interior cavity and a longitudinal axis, the vial having a first end, an opposed second end, and a circumferential sidewall, wherein the first end is open for access to the interior cavity and the second end is closed, and wherein the circumferential sidewall comprises a first sidewall portion located proximate the first end projecting inwardly into the interior cavity, and a second sidewall portion positioned between the first sidewall portion and the second end projecting inwardly into the interior cavity.

2. The container of claim 1, wherein the second sidewall portion is positioned substantially midway between the first and the second ends.

3. The container of claim 1, wherein the second sidewall portion is positioned nearer to the first end than the second end.

4. The container of claim 1, wherein the second sidewall portion is positioned nearer to the second end than the first end.

5. The container of claim 1, wherein the sidewall has a substantially round cross section taken in a plane transverse to the longitudinal axis.

6. The container of claim 5, wherein the second sidewall portion extends circumferentially around the sidewall.

7. The container of claim 1, wherein the sidewall has an outer surface and an inner surface facing the interior cavity, the inner surface comprising the second sidewall portion.

8. The container of claim 1, further comprising a substantially tubular insert disposed within the interior cavity, wherein at least a portion of an outer surface of the tubular insert engages at least a portion of each of the first and second sidewall portions, and wherein the first and second sidewall portions maintain the substantially tubular insert in substantial coaxial alignment with the longitudinal axis.

9. A container for holding a sample, the container comprising:
a substantially cylindrical vial defining an interior cavity and a longitudinal axis, the vial having a first end, a second end, and a circumferential sidewall, wherein the first end is open for access to the interior cavity and the second end is closed;
a plurality of projections positioned on the sidewall between the first and second ends, the projections extending inwardly into the interior cavity.

10. The container of claim 9, wherein the projections are positioned midway between the first and the second ends.

11. The container of claim 9, wherein the projections are positioned nearer to the first end than the second end.

12. The container of claim 9, wherein the projections are positioned nearer to the second end than the first end.

13. The container of claim 9, further comprising a substantially tubular insert disposed within the interior cavity, wherein at least a portion of an outer surface of the tubular insert engages at least a portion of each of the projections, and wherein the projections maintain the substantially tubular insert in substantial coaxial alignment with the longitudinal axis.

14. A container for holding a sample, the container comprising:
a substantially cylindrical vial defining an interior cavity and a longitudinal axis, the vial having a first end, a second end, and a circumferential sidewall, wherein the first end is open for access to the interior cavity and the second end is closed, and wherein the circumferential sidewall comprises a first sidewall portion located proximate the first end projecting inwardly into the interior cavity, and a second sidewall portion positioned between the first sidewall portion and the second end projecting inwardly into the interior cavity; and
a substantially tubular insert disposed within the interior cavity, wherein at least a portion of an outer surface of the tubular insert engages at least a portion of each of the first and second sidewall portions, and wherein the first and second sidewall portions maintain the substantially tubular insert in substantial coaxial alignment with the longitudinal axis.

15. A vessel according to claim 14, wherein the second sidewall portion is positioned midway between the first and the second ends.

16. A vessel according to claim 14, wherein the second sidewall portion is positioned nearer to the first end than the second end.

17. A vessel according to claim 14, wherein the second sidewall portion is positioned nearer to the second end than the first end.

18. A vessel according to claim 14, wherein the sidewall has a round cross section.

19. A vessel according to claim 14, wherein the sidewall has an outer surface and an inner surface facing the interior cavity, the inner surface comprising the second sidewall portion.

20. The container of claim 14, wherein the sidewall has a substantially round cross section taken in a plane transverse to the longitudinal axis.
